(19) United States
(12) Patent Application Publication
(10) Pub. No.: US 2025/0316671 A1
(43) Pub. Date: Oct. 9, 2025

(54) Method for Coating an Electrically Conductive Web of Film with an Electrically Conductive Adhesion Promoter

(71) Applicants: Matthews International GmbH, Vreden (DE); Matthews International Corporation, Pittsburgh, PA (US)

(72) Inventor: Thomas HACKFORT, Ahaus-Alstätte (DE)

(21) Appl. No.: 18/864,621

(22) PCT Filed: May 8, 2023
(86) PCT No.: PCT/DE2023/100330

§ 371 Date: Nov. 11, 2024

(30) Foreign Application Priority Data
May 13, 2022 (DE) 10 2022 112 095.3

(51) Int. Cl. H01M 4/04

(52) U.S. Cl. CPC H01M 4/0409; H01M 4/0404; H01M 4/0435; H01M 4/0471

(57) ABSTRACT

The invention relates to a method for coating an electrically conductive film web (210) with an electrically conductive adhesive (1), characterized in that the method comprises providing an electrically conductive film web (210) and coating the film web (210) with an electrically conductive adhesive (1).

The invention relates to a method for coating an electrically conductive film web with an electrically conductive adhesive.

For the application of decorative structural elements to web-shaped substrates, for example in the production of structural wallpaper, it is known to apply expandable materials, for example based on polyurethane, to the substrate by means of a doctor blade through a screening roller. Such methods are known, for example, from JP 05262509 B2 and from EP 2322711 B1. The known methods have the disadvantage that the applied materials must first be dried and/or cured after application before the coated web can be further processed, even if it is only to be wound up for transport.

In the production of electrodes for electrical energy storage devices, the film web coated with an electrically conductive adhesive for providing the current collector is bonded to a pre-calendered dry electrode film in a multi-roller calender. For this purpose, the dry electrode film and the film web with their adhesive are introduced into a roller gap facing the dry electrode film, whereby the dry electrode film is electrically connected to the film web via the adhesive and is further compacted. Such a calendering process is described in WO 2020/150254 A1.

It is the object of the invention to further develop the method mentioned at the outset in such a way that it enables the further processing of the film web coated with an electrically conductive adhesive, in particular in a calendering process for dry electrode production, already immediately after the film web has been coated.

This object is achieved by a method having the features of claim 1. Advantageous embodiments are the subject of the respective dependent claims.

The invention relates to a method for coating an electrically conductive film web with an electrically conductive adhesive, characterized in that the method comprises providing an electrically conductive film web and coating the film web with an electrically conductive adhesive.

The method according to the invention makes it possible in particular to carry out the coating of the electrically conductive film web with the adhesive in-situ for the calendering process for the dry electrode film production. For example, in a modification of the prior art, the conductive film web coated with the adhesive can be first coated immediately before the film web is introduced into the roller gap and introduced into the roller gap as a coated film web instead of being introduced into the roller gap of the calender from an unwinding spool. It may be that the adhesive on the coated film web has not yet or not yet completely cured or dried when it is introduced into the roller gap, which can further increase the adhesion of the dry electrode film to the film web. In particular, the calendering process can comprise further drying or curing steps that cure, dry or crosslink the adhesive to a final strength. For this purpose, the multi-roller calender used in the calendering process can have at least one heated roller. Preferably, the heated roller is one of the rollers forming the roller gap into which the film web coated with the adhesive is introduced after coating in order to be connected to the dry electrode film.

The adhesive can be provided as a liquid adhesive with a solvent which is volatile under normal conditions. Normal conditions can mean ambient pressure and/or ambient temperature. Normal conditions can mean room pressure and/or room temperature, e.g. a pressure of approximately 1 bar and/or a temperature of approximately 20° C.

The method can comprise drying and/or curing the electrically conductive adhesive after coating the film web with the electrically conductive adhesive.

The coating of the electrically conductive film web can be carried out using a gravure printing process and/or a flexographic printing process.

During the coating, the electrically conductive film web to be coated can be or will be passed through a roller gap between a printing plate cylinder and a counter-pressure cylinder. The printing plate cylinder and/or the counter-pressure cylinder can be set up to apply adhesive to the film web.

The electrically conductive adhesive coated onto the electrically conductive film web can be cured after coating. It can be provided that the electrically conductive adhesive coated onto the electrically conductive film web can be dried and/or tempered and/or crosslinked after coating.

The film web coated with the electrically conductive adhesive can, if necessary after a curing step, be wound up or supplied directly into a calendering unit for the production of a dry electrode. The calendering unit can be or comprise a multi-roller calendering unit and/or a multi-roller calender. The calendering unit can be set up and/or used, for example, for the production of a dry electrode, e.g. a lithium ion electrode.

The method can comprise the tempering of the electrically conductive adhesive prior to coating the adhesive onto the electrically conductive film web. The method can comprise a or the tempering of an electrically conductive adhesive prior to coating the adhesive onto the electrically conductive film web.

The electrically conductive adhesive can be introduced into a large number of cells of a printing plate cylinder for coating. At least one, several or all of the cells can be or comprise an engraving. At least one, several or all of the cells and/or engraving can extend into the printing plate cylinder and/or be or comprise a recess. The cells and/or engraving can be grooved and/or comprise grooves.

The coated electrically conductive film web can be supplied to a second roller gap of a multi-roller calender, wherein the second roller gap can accommodate the film web. The second roller gap can laminate the coated electrically conductive film web to a first dry electrode film and a second dry electrode film to form a double-sided dry electrode. The second roller gap can laminate a first dry electrode film and a second dry electrode film onto the film web, in particular the coated electrically conductive film web to form a double-sided dry electrode. The first dry electrode film and/or the second dry electrode film is/are laminated or applied or can be laminated or applied to the coated electrically conductive film web and it/they is/are connected or can be connected to the coated electrically conductive film web.

The method can comprise the steps:
a. providing a first dry electrode material with a first supply system for dry electrode material,
b. forming a first roller gap between a first and a second calender roller;
c. calendering a first dry electrode film made of the first dry electrode material in the first roller gap.

The method can comprise forming a second roller gap between a third calender roller and a further calender roller, wherein the first dry electrode film can be transferred into the second roller gap after leaving the first roller gap. The further calender roller can be arranged upstream of the third calender roller. It can be provided that the further calender roller can be the second calender roller or can correspond to it. By “upstream” it can be meant that the first dry electrode film is or will be guided first to, into or through the first roller gap before the first dry electrode film is or will be guided to, into or through the second roller gap.

It can be provided that the calendering of the first dry electrode film made of the first dry electrode material is carried out in the first roller gap with a rotational speed of the second calender roller which can be greater than the rotational speed of the first calender roller.

The third calender roller can be operated at a rotational speed which can be greater than a rotational speed of the further calender roller. The third calender roller can be operated at a rotational speed which can be greater than a rotational speed of the second calender roller.

The method can comprise the steps:
a. forming a third roller gap between a fourth calender roller and a still further calender roller,
b. receiving the second dry electrode material from the second supply system for dry electrode material in the third roller gap, and
c. forming a second dry electrode film in the third roller gap.

The still further calender roller can be the third calender roller or correspond to it. The still further calender roller and/or the third calender roller can be arranged adjacent to and/or downstream of the fourth calender roller. By “upstream” it can be meant that the second dry electrode film is or will be guided first to, into or through the third roller gap before the second dry electrode film is or will be guided to, into or through the second roller gap.

The second dry electrode film can be or will be calendered in the third roller gap. It can be provided that the second dry electrode film can be formed and/or calendered in the third roller gap with a rotational speed of the third calender roller and/or the still further calender roller, which can be greater than the rotational speed of the fourth calender roller.

The method can comprise introducing the coated conductive film web into the second roller gap, wherein the coated conductive film web can be laminated with the first dry electrode film and the second dry electrode film, whereby a double-sided dry electrode can be obtained.

The coated conductive film web can be introduced into the second roller gap immediately after coating, wherein the film web can be introduced into the second roller gap either after complete drying and/or curing or at least before complete drying and/or curing.

The coating of the film web can be carried out in-situ by supplying the electrically conductive film web to the second roller gap of the multi-roller calender.

The coated conductive film web can be cured, dried and/or crosslinked in the multi-roller calender after being introduced into the second roller gap.

The film web can be heated for curing, drying or cross-linking. In some embodiments, the film web and/or the adhesive can be heated for curing, drying or crosslinking by heating the coated film web with the first and/or second dry electrode film over a heated roll of the multi-roller calender. The multi-roller calender can have at least one heated roll. It can be provided that one, several or all of the calender rollers, for example the first calender roller, the second calender roller, the third calender roller, the fourth calender roller, the further calender roller and/or the still further calender roller, are or can be heated.

Further details of the invention are explained using the figures below. In the figures:

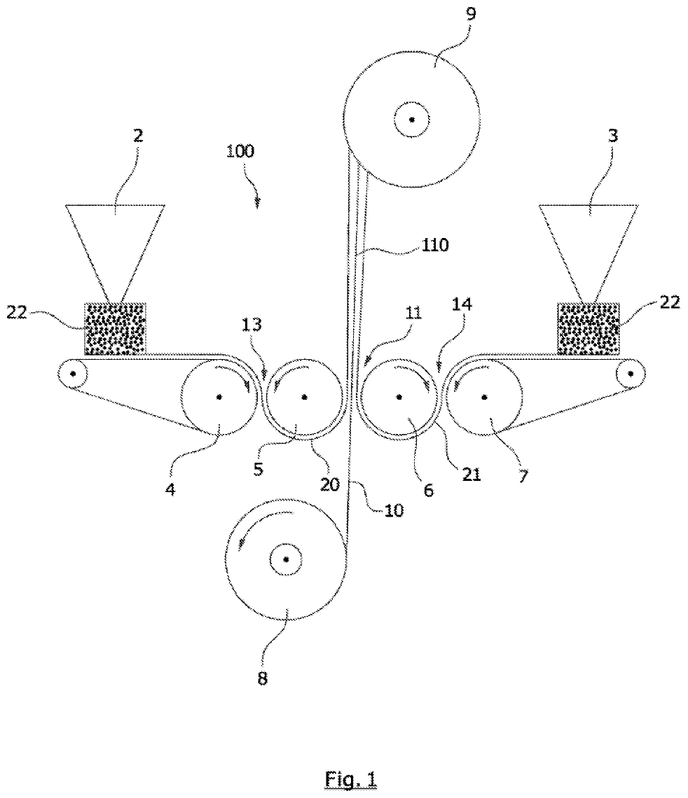

FIG. 1 shows an exemplary embodiment of a multi-roller calender according to the prior art;

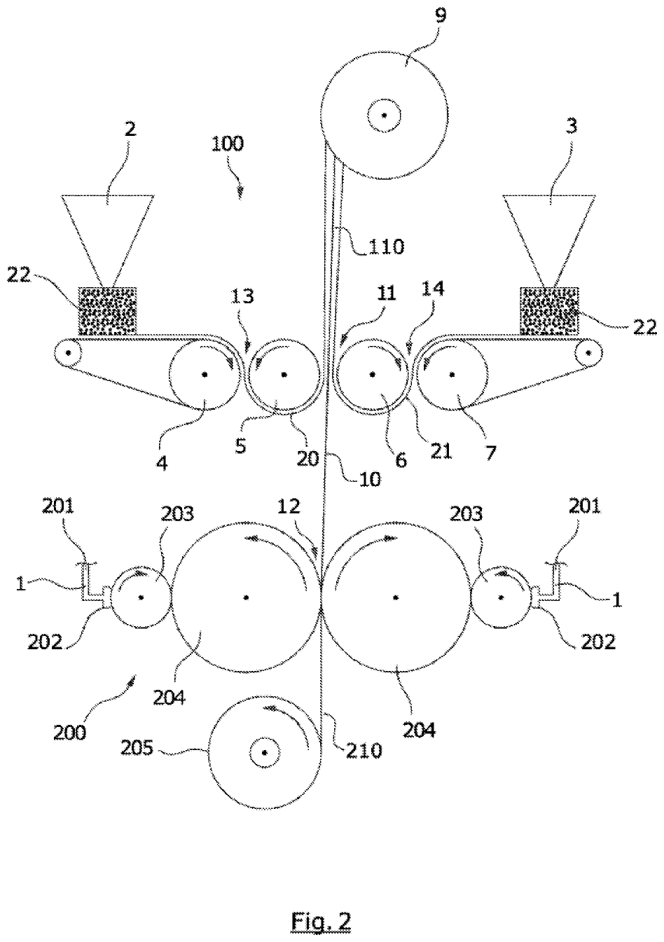

FIG. 2 shows a multi-roller calender using an embodiment of the method according to the invention; and

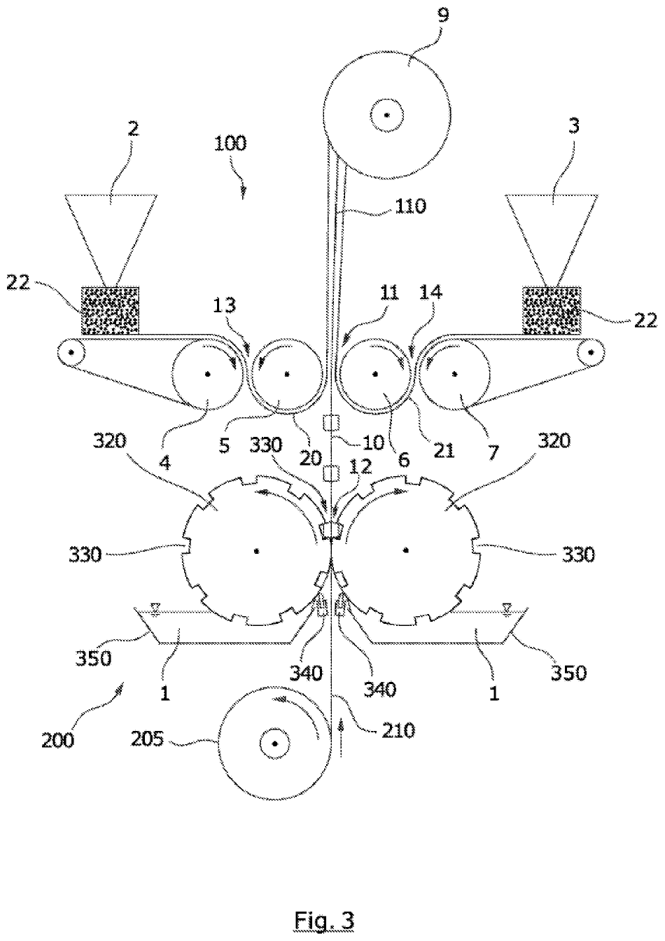

FIG. 3 shows a multi-roller calender using a further embodiment of the method according to the invention; and

FIG. 1 shows a multi-roller calender 100 with which two dry electrode films can be produced and laminated onto a current collector 10 to form a double-sided electrode. The multi-roller calender 100 can have more than one roller, e.g. four rollers 4, 5, 6, 7. The current collector 10 can be or comprise a film web 10 coated with an adhesive 1. The film web 10 coated with an adhesive 1 can also be referred to as a current collector 10. The film web 10 coated with adhesive 1 can, for example, be or comprise a film web 10 coated with adhesive 1.

In FIG. 1, two supply systems 2 and 3 for dry electrode material and four rollers 4, 5, 6 and 7 can be seen. An adhesion-promoter-coated current collector 10 can be provided from a supply spool 8. A first dry electrode film 20 can be formed by calendering particles, e.g. particulate dry electrode material 22, from the supply system 2 through a first gap 13 between the rollers 4 and 5. A second dry electrode film 21 can be formed by calendering particles, e.g. particulate dry electrode material 22, from the supply system 3 through a third gap 14 formed between the rollers 6 and 7. Both dry electrode films 20 and 21 can be laminated to a first or second opposite side of the adhesion-promoter-coated film web 10 and/or to a first or second opposite side of the current collector 10. The lamination can be carried out by compressing, in particular calendering, the dry electrode films 20 and 21 and the adhesion-promoter-coated film web 10, and/or the current collector 10, between a second gap 11 formed between the rollers 5 and 6. In addition to lamination, this second gap 11 can also allow additional calendering to determine the film thickness of the dry electrode films 20 and 21. After lamination between the rollers 5 and 6, the double-sided electrode 110 is collected for further processing, e.g. via a winding spool 9. The electrode 110 can be or comprise a dry electrode. The dry electrode 110 can be or comprise a lithium ion electrode, and/or be formed by or used in, or for, the manufacture of a lithium ion electrode. The electrode 110 and/or the dry electrode 110 can be or comprise a double-sided electrode and/or a double-sided dry electrode.

When applying and/or laminating the first dry electrode film 20 to the film web 10, the first dry electrode film 20 can be glued to the film web 10 and/or glued onto the film web 10, for example via or by means of adhesive 1 applied to the film web 10. When applying and/or laminating the second dry electrode film 21 to the film web 10, the second dry electrode film 21 can be glued to the film web 10 and/or glued onto the film web 10, for example via or by means of adhesive 1 applied to the film web 10.

The first dry electrode film 20 can be or will be calendered, for example by the roller pair 4, 5 and/or a first roller 4 and a second roller 5. The multi-roller calender 100 can comprise the roller pair 4, 5 or the first roller 4 and the second roller 5. The roller 4 and/or the roller 5 can be or comprise a calender roller. In some embodiments, it can be provided that one of the rollers 4, 5 of the roller pair can have a higher rotational speed than the other roller of the roller pair. For example, the rotational speed of the second roller 5 can be greater than the rotational speed of the first roller 4, and/or the second roller 5 can rotate at a higher speed than the first roller 4. However, in some embodiments it can also be provided that the rotational speed of the first roller 4 can be greater than the rotational speed of the second roller 5, and/or the first roller 4 can rotate at a higher speed than the second roller 5. However, in some embodiments the two rollers 4, 5 can also have the same rotational speed and/or rotate at the same speed.

The first dry electrode film 20 can be produced in a first gap 13, which can be formed by the roller pair 4, 5 and/or the roller 4 and the roller 5. For example, dry electrode material 22 can be introduced into the first gap 13 for this purpose. In the first gap 13, the dry electrode material 22 can be calendered, pressed and/or compressed to form the first dry electrode film 20.

The second dry electrode film 21 can be or will be calendered, for example by the roller pair 6, 7 and/or a third roller 6 and a fourth roller 7. The multi-roller calender 100 can have the roller pair 6, 7 or the third roller 6 and the fourth roller 7. The roller 6 and/or the roller 7 can be or comprise a calender roller. In some embodiments, it can be provided that one of the rollers 6, 7 of the roller pair can have a higher rotational speed than the other roller of the roller pair. For example, the rotational speed of the fourth roller 7 can be greater than the rotational speed of the third roller 6, and/or the fourth roller 7 can rotate at a higher speed than the third roller 6. However, in some embodiments it can also be provided that the rotational speed of the third roller 6 can be greater than the rotational speed of the fourth roller 7, and/or the third roller 6 can rotate at a higher speed than the fourth roller 7. However, in some embodiments the two rollers 6, 7 can also have the same rotational speed and/or rotate at the same speed.

Alternatively or additionally, it can be provided that the second roller 5 and the third roller 6 can have a different rotational speed and/or rotate at a different rotational speed. It can be provided that the rotational speed of the second roller 5 can be higher than that of the third roller 6, and/or the second roller 5 can rotate at a rotational speed that can be greater than that of the third roller 6. It can be provided that the rotational speed of the third roller 6 can be higher than that of the second roller 5, and/or the third roller 6 can rotate at a rotational speed that can be greater than that of the second roller 5. However, in some embodiments the second roller 5 and the third roller 6 can have the same rotational speed and/or rotate at the same rotational speed.

It can be provided that the rotational speeds of one, several or all of the rollers, in particular the first roller 4, the second roller 5, the third roller 6 and/or the fourth roller 7, can be individually selected, controlled and/or regulated. The rotational speeds of one, several or all of the rollers, in particular the first roller 4, the second roller 5, the third roller 6 and/or the fourth roller 7, can be selected and/or adjusted depending on the type, material and/or composition of the dry electrode material 22, the first dry electrode film 21, the second dry electrode film 22, the adhesive 1 and/or the film web 210 and/or the film web 10.

The second dry electrode film 21 can be or be produced in a third gap 14 which can be or be produced by the roller pair 4, 5 and/or the roller 4 and the roller 5. For example, dry electrode material 22 can be introduced into the first gap 13. In the third gap 14, the dry electrode material 22 can be calendered, pressed and/or compressed to form the first dry electrode film 20.

It can be provided that the second roller 5 and the third roller 6 form a roller pair 5, 6. The multi-roller calender 100 can comprise the roller pair 5, 6 or the second roller 5 and the third roller 6. The roller 6 and/or the roller 7 can be or comprise a calender roller. The roller pair 5, 6 can serve to laminate the first dry electrode film 20 and/or the second dry electrode film 21 onto the film web 10. A second gap 11 can be formed between the rollers 5, 6. The rollers 5, 6 and/or the roller pair 5, 6 can form a second gap 11. The film web 10 can be introduced into the second gap 11 and/or passed through the second gap 11.

The first dry electrode film 20 can be introduced into the second gap 11 between the rollers 5, 6 and/or the gap 11 of the roller pair 5, 6, and/or passed through the second gap 11. The second dry electrode film 21 can be introduced into the second gap 11 between the rollers 5, 6 and/or the gap 11 of the roller pair 5, 6, and/or passed through the second gap 11. The film web 10, the first dry electrode film 20 and/or the second dry electrode film 21 can be guided into the second gap 11 such that the first dry electrode film 20 can be applied and/or laminated on one side of the film web 10 and the second dry electrode film 21 can be applied and/or laminated on an opposite side of the film web 10.

In some embodiments, the roller pair 4, 5 can be arranged opposite the roller pair 6, 7. In some embodiments, the roller pair 4, 5 can be arranged on one side of the film web 10, and the roller pair 6, 7 on another and/or opposite side of the film web 10. The first roller 4 can be arranged substantially adjacent to the second roller 5, and/or vice versa. The third roller 6 can be arranged substantially adjacent to the fourth roller 7, and/or vice versa. The second roller 5 can be arranged substantially adjacent to the third roller 6, and/or vice versa.

It can be provided that the second roller 5 can be part of the roller pair 4, 5 which can form the first dry electrode film 20, as well as part of the roller pair 5, 6 which can apply and/or laminate the first dry electrode film 20 onto the film web 10. It can be provided that the third roller 6 can be part of the roller pair 6, 7 which can form the second dry electrode film 21, as well as part of the roller pair 5, 6 which can apply and/or laminate the second dry electrode film 21 onto the film web 10.

In some embodiments, the second roller 5 can be arranged upstream of the third roller 6. “Upstream” can mean a direction opposite to the transport or conveying direction of the first dry film 20. The first dry film 20 can be guided first through the first gap 13 and then through the second gap 11 and/or at least contact the roller 5 first at, in or near the first gap 13 and then at, in or near the second gap 11.

In some embodiments, the third roller 6 can be arranged downstream of the fourth roller 7. “Downstream” can mean a direction in the transport or conveying direction of the second dry film 21. The second dry film 21 can be guided first through the third gap 13 and then through the second gap 11 and/or at least contact the roller 6 first at, in or near the third gap 14 and then at, in or near the second gap 11.

The multi-roller calender 100 according to the invention shown in FIG. 2 and/or described below can have one, several or all of the features and/or advantages of the multi-roller calender 100 shown in FIGS. 1 and/or 3 and described above and/or below.

The coating of the film web 210 with adhesive 1, and/or the application of adhesive 1 to the film web 210, can be carried out and/or done using a flexographic printing process. Using the flexographic printing process, adhesive 1 can be applied and/or coated onto the film web 210 not yet provided with adhesive in order to obtain the film web 10 coated and/or provided with adhesive 1.

Due to the described arrangement of the rollers, e.g. the first roller 4, second roller 5, third roller 6 and/or fourth roller 7, the roller calender 100 can be designed to save space and/or require a small installation area.

In one embodiment of the invention, in contrast to the multi-roller calender 100 shown in FIG. 1, the multi-roller calender 100 shown by way of example in FIG. 2 has, instead of the supply spool 8 for the film web 10 coated with adhesive or for the current collector 10, a flexographic printing unit 200 with which an uncoated, electrically conductive film 210, for example an aluminum film, is coated on both sides with an adhesive 1 in order to form a film web 10 coated with adhesive 1 and/or the current collector 10. Liquid adhesive 1 is supplied to a chamber doctor blade 202 via a supply line 201. The liquid adhesive 1 is applied to a structured anilox roller 203 via the chamber doctor blade 202 and transferred from the anilox roller 203 to a printing plate cylinder 204. The adhesive-free film web 210 is pulled off from a supply spool 205 and introduced around a roller gap 12 between the printing plate cylinder 204 and a second printing plate cylinder 204. When the adhesive 1 has been transferred from the printing plate cylinder 204 to the film web 210, the coated film web 210 is supplied as current collector 10 and/or as film web 10 coated with adhesive 1 in the manner described with reference to FIG. 1 into the second gap 11 of the multi-roller calender 100 in order to be connected on both sides to a calendered dry electrode film 20, 21.

Further deviating from the prior art, the adhesive 1 can not yet be (fully) cured, dried and/or crosslinked when the current collector 10 is introduced into the multi-roller calender 100 and/or the second gap 11, and can therefore still be liquid or viscous or have a reduced strength. Accordingly, the further drying, curing and/or crosslinking of the adhesive 1 takes place either when the film web 210 coated with the adhesive 1 is bonded to the dry electrode films 20, 21, or in a subsequent calendering step in which the dry electrode films 20, 21 arranged on the opposite sides are further compressed to a final thickness or final density, or when the current collector 10 coated with the dry electrode films 20, 21 is transported in the multi-roller unit 100, wherein the coated current collector 10 rests against the jacket of a heated roller.

The coating of the film web 210 with adhesive 1, and/or the application of adhesive 1 to the film web 210, can be carried out and/or done using a flexographic printing process. Using the flexographic printing process, adhesive 1 can be applied and/or coated onto the film web 210 not yet provided with adhesive in order to obtain the film web 10 coated and/or provided with adhesive 1.

The multi-roller calender 100 according to the invention shown in FIG. 3 and/or described below can have one, several or all of the features and/or advantages of the multi-roller calender 100 shown in FIGS. 1 and/or 2 and described above and/or below.

In one embodiment of the invention, in a modification to the embodiment shown in FIG. 2, as shown by way of example in FIG. 3, a gravure printing unit 300 is used for coating the film web 210 with the adhesive 1. The adhesive 1 is held in a tray 350 into which a horizontal plate cylinder 320 projects over its underside. The plate cylinder 320 has a cell engraving 330 for receiving the adhesive 1. The cell engraving 330 can also be referred to as cell 330. The cell 330 can have an engraving that can extend into the plate cylinder 320. The cell(s) 330, or the engraving, can have a pattern that can enable and/or promote the removal and/or capture of adhesive 1 from the tray 330. The one or more cells 330, or the engraving, can comprise grooves and/or recesses.

On the side of the cylinder jacket facing away from the direction of rotation of the tray 350, a doctor blade 340 is arranged, which removes excess adhesive 1 so that the adhesive 1 remains only in the cells 330. A roller gap 12 is formed with respect to a second plate cylinder 320 on an upper side of the plate cylinder 320 facing away from the doctor blade 340 in the direction of rotation of the plate cylinder 320. The first plate cylinder 320 and/or the second plate cylinder 320 can be or comprise a printing plate cylinder and/or a counter-pressure cylinder. The first plate cylinder 320 can be or comprise a printing plate cylinder and the second plate cylinder 320 can be or comprise a counter-pressure cylinder. The first plate cylinder 320 be or comprise a counter-pressure cylinder and the second plate cylinder 320 can be or comprise a printing plate cylinder.

The film web 210 to be coated is passed through the roller gap 12. The contact pressure of the plate cylinder 320 and the second plate cylinder 320 is so high that the film web 210 to be coated comes into contact with the adhesive 1 in the cells 330 in the roller gap 12 and the adhesive 1 is transferred from the plate cylinder 320 to the film web 210.

The film web 10, 210 can be electrically conductive. The film web 210 not yet coated with adhesive 1 and/or the film web 10 coated with adhesive 1 can serve as current collector and/or current collector of an or the electrode 110.

In some embodiments, the adhesive 1 can be applied to the film web 210 in spots or sections. It can be provided that when applying and/or laminating the dry film 20, 21 and/or gluing the dry film 20, 21, the adhesive applied in spots or sections is or can be distributed along the film web 10.

In some embodiments, the adhesive 1 can be applied to the film web 210 continuously and/or at least in webs or strips running along the conveying direction of the film web 210.

The adhesive 1 can be electrically conductive. The adhesive 1 can be liquid and be produced with a solvent which is volatile under normal conditions. Normal conditions can be, for example, room temperature, e.g. 20° C., and/or a pressure of approximately 1 bar.

It can be provided that the adhesive 1, in particular electrically conductive adhesive 1, can be tempered before coating. The adhesive 1, in particular electrically conductive adhesive 1, can be tempered before coating, applying and/or laminating the film web 10. In some embodiments, the adhesive 1 can, for example, be tempered and/or warmed or heated to such a temperature that it can have a viscosity at which it can, for example, be easily applied to the film web 10 and/or carried along by the rollers or cylinders 204, 320 and/or cells 330. Depending on the type and/or composition of the adhesive 1, the adhesive 1 can be or will be tempered at different temperatures. The tempering and/or temperature can be selected and/or carried out depending on the type, material and/or composition of the adhesive 1. A corresponding device can be provided for the tempering, for example a tempering and/or heating device which can temper the adhesive 1.

In some embodiments, the film web 10 coated with the electrically conductive adhesive 1 can be wound up, e.g. on or with a or the winding spool 9 (not shown in the figures). It can be provided that the film web 10 coated with the electrically conductive adhesive 1 and wound on the winding spool 9 is supplied to a multi-calender 100, as described for example with reference to FIG. 1, so that an electrode 110, in particular a dry electrode 110, can be produced. It can be provided that the winding spool 9 can serve as a supply spool 8 or can correspond to a supply spool 8 which can provide the film web 10 coated with the adhesive 1.

It can be provided that the electrically conductive adhesive 1 coated onto the electrically conductive film web 10 can be dried and/or tempered and/or crosslinked after coating. For this purpose, a corresponding device can be provided, for example a heating device or the like. In some embodiments, the coated and cured film web 10 can be wound up, e.g. on or with a winding spool 9 (not shown in the figures).

Alternatively or additionally, the coated film web 10 can be supplied to the multi-roller calender 100. In some embodiments, the film web 10 or the adhesive 1 can be cured. In some embodiments, the film web 10 or the adhesive 1 can be at least partially cured. In some embodiments, the adhesive 1 applied to the film web 10 can be at least partially or completely liquid.

In some embodiments, it can be provided that cured adhesive 1 can be at least partially liquefied and/or the curing can be at least partially reversed before laminating the film web 10 with the first dry electrode film 20 and/or the second dry electrode film 21. However, in some other embodiments it can also be provided that the first dry electrode film 20 and/or the second dry electrode film 21 can be laminated on or with the cured adhesive 1 or film web 10.

Alternatively or additionally, it can be provided that the film web 10 covered and/or coated with adhesive 1 can be led and/or supplied into the second gap 11 and/or the multi-roller calender 100 immediately after the coating. The film web 10 covered and/or coated with adhesive 1 can be laminated and/or bonded to the first dry electrode film 20 and/or the second dry electrode film 21 immediately after the coating.

The coating of the film web 210 can be carried out in-situ by supplying the electrically conductive film web 10 to or into the multi-roller calender 100 and/or the second gap 11. In some embodiments, film web 210 not yet coated with adhesive 1 can be introduced into the multi-roller calender 100 and/or the second gap 11, and the adhesive 1 can be applied and/or coated substantially at or in the gap 11. It can be provided that the adhesive 1 can be coated and/or applied to the film web essentially immediately and/or only shortly before the lamination of the first dry electrode film 21 and/or the second dry electrode film 21.

Alternatively or additionally, in some embodiments, the adhesive 1 and/or the film web 10 can be cured, dried and/or crosslinked only after introduction into the multi-roller calender 100 and/or the second gap 11. It can be provided that the adhesive 1 and/or the film web 10 can only be cured, dried and/or crosslinked after the application of the first dry electrode film 20 and/or the second dry electrode film 21 to the film web 10, and/or at least after the first dry electrode film 20 and/or the second dry electrode film 21 have been contacted with the film web 10. For this purpose, a suitable device can be provided, for example a heating device or the like.

The film web 10 and/or the adhesive 1 can be heated for curing, drying or crosslinking. For example, the coated film web 10 with the first dry electrode film 20 and/or the second dry electrode film 21 can be heated via a heated roller of the multi-roller calender 100. The heated roller can, for example, be a calender roller, e.g. the second roller 5 and/or the third roller 6. In some embodiments, the multi-roller calender 100 can alternatively or additionally comprise one or more further heated rolls (not shown in the figures). In some embodiments, the further heated roller, or optionally at least one, several or all of the further heated rollers, can be arranged in the transport or conveying direction of the film web 10 behind the second and third rollers 5, 6, and/or behind the roller pair 5, 6.

In and/or with the multi-roller calender 100, an electrode 110, preferably a dry electrode 110, can be formed and/or produced, for example as described above, for example by applying dry electrode material 22 and/or the dry electrode film 20, 21.

The features of the invention disclosed in the above description, in the figures, and in the claims can be essential for the implementation of the invention both individually and in any combination.

### LIST OF REFERENCE NUMERALS

1 Adhesive
2 Supply system
3 Supply system
4 Roller
5 Roller
6 Roller
7 Roller
8 Supply spool
9 Winding spool
10 Current collector
11 Second roller gap
12 Roller gap
13 First roller gap
14 Third roller gap
20 Dry electrode film
21 Dry electrode film
22 Dry electrode material
100 Multi-roller calender
110 Electrode
200 Flexographic printing unit
201 Supply line
202 Chamber doctor blade
203 Anilox roller
204 printing plate cylinder
205 Supply spool
210 Film web
300 Gravure printing unit
300 Plate cylinder
330 Cell
340 Doctor blade
350 Tray

1. A method for coating an electrically conductive film web with an electrically conductive adhesive, characterized in that the method comprises providing an electrically conductive film web and coating the film web with an electrically conductive.

2. The method according to claim 1, wherein the adhesive is provided as a liquid adhesive with a solvent which is volatile under normal conditions.

3. The method according to claim 1, comprising drying and/or curing the electrically conductive adhesive after coating the film web with the electrically conductive adhesive.

4. The method according to claim 1, wherein the coating of the electrically conductive film web is carried out using a gravure printing process and/or a flexographic printing process.

5. The method according to claim 4, wherein during coating the electrically conductive film web to be coated is passed through a roller gap between a printing plate cylinder and a counter-pressure cylinder.

6. The method according to claim 1, wherein the electrically conductive adhesive coated on the electrically conductive film web is cured, preferably dried and/or tempered and/or crosslinked after coating.

7. The method according to n claim 1, wherein optionally after a curing step, the film web coated with the electrically conductive adhesive is wound up or supplied directly into a calendering unit, preferably a multi-roller calender, for the production of a dry electrode, preferably a lithium ion electrode.

8. The method according to claim 1, comprising tempering the electrically conductive adhesive, in particular an adhesive, before coating the adhesive onto the electrically conductive film web.

9. The method according to claim 1, wherein the electrically conductive adhesive for coating is introduced into a plurality of cells of a printing plate cylinder.

10. The method according to claim 1, wherein the coated electrically conductive film web is supplied to a second roller gap of a multi-roller calender, the second roller gap receiving the film web and laminating it onto a first dry electrode film and a second dry electrode film to form a double-sided dry electrode.

11. The method according to claim 10, comprising the steps:
a. providing a first dry electrode material with a first supply system for dry electrode material,
b. forming a first roller gap between a first and a second calender roller;
c. calendering a first dry electrode film made of the first dry electrode material in the first roller gap, preferably with a rotational speed of the second calender roller which is greater than the rotational speed of the first calender roller.

12. The method according to claim 11, comprising forming a second roller gap between a third calender roller and a further calender roller, which is preferably arranged upstream of the third calender roller, wherein the first dry electrode film is transferred into the second roller gap after leaving the first roller gap, wherein the further calender roller is preferably the second calender roller.

13. The method according to claim 12, wherein the third calender roller is operated at a rotational speed which is greater than a rotational speed of the further calender roller.

14. The method according to am claim 10, comprising the steps:
a. forming a third roller gap between a fourth calender roller and yet another calender roller, which is preferably arranged next to and/or downstream of the fourth calender roller, wherein the other calender roller is preferably the third calender roller,
b. receiving the second dry electrode material from a second dry electrode material supply system in the third roller gap, and
c. forming a second dry electrode film in the third roller gap.

15. The method according to claim 10, comprising introducing the coated conductive film web into the second roller gap, wherein the coated conductive film web is laminated with the first dry electrode film and the second dry electrode film, thereby obtaining a double-sided dry electrode.

16. The method according to claim 10, wherein the coated conductive film web is introduced into the second roller gap immediately after coating, wherein the film web is introduced into the second roller gap either after complete drying and/or curing or at least before complete drying and/or curing.

17. The method according to claim 16, wherein the coating of the film web is carried out in-situ with supplying of the electrically conductive film web to the second roller gap of the multi-roller calender.

18. The method according to claim 16, wherein the coated conductive film web is cured, dried and/or crosslinked in the multi-roller calender after being introduced into the second roller gap.

19. The method according to claim 18, wherein the film web is heated for curing, drying or crosslinking, preferably by heating the coated film web with the first and/or the second dry electrode film via a heated roller of the multi-roller calender.
